(19) United States
(12) Patent Application Publication
(10) Pub. No.: US 2002/0104088 A1
(43) Pub. Date: Aug. 1, 2002

(54) Method for searching for television programs

(75) Inventors: Thomas Francis McGee III, Garrison, NY (US); Nevenka Dimitrova, Yorktown Heights, NY (US); Lalitha Agnihotri, Fishkill, NY (US)

Correspondence Address: MICHEAL E. MARION, Corporate Patent Counsel, U.S. Philips Corporation, 580 White Plains Road, Tarrytown, NY, 10591, US

(73) Assignee: PHILIPS ELECTRONICS NORTH AMERICAS CORP.

(21) Appl. No.: 09/771,870

(22) Filed: Jan. 29, 2001

(51) Int. Cl. H04N 7/173; G06F 7/00; G06F 17/30; G06F 3/00; H04N 5/445; G06F 13/00

(52) U.S. Cl. 725/51; 725/112; 725/133; 725/47

(57) ABSTRACT

There is disclosed an improved method for using key objects obtained from Internet sites to search for and locate television programs. An advantageous embodiment of the improved method of the present invention comprises the steps of: 1) identifying key objects in Internet documents, 2) sending the key objects to a search capable video recorder, 3) conducting a key object search with the search capable video recorder to locate television programs that contain the key objects, 4) providing to a viewer the search results of the key object search that identify television programs that contain the key objects, 5) selecting television programs that contain the key objects in response to a viewer instruction, and 6) recording the television programs that are selected by the viewer from the search results.

### CROSS-REFERENCE TO RELATED APPLICATIONS

The present invention is related to the invention disclosed in U.S. patent application Ser. No. 09/442,960 filed Nov. 18, 1999 by Dimitrova et al., entitled “APPARATUS AND METHOD FOR AUDIO/DATA/VISUAL INFORMATION SELECTION.” This patent application is assigned to the assignee of the present invention. The disclosures of this related patent application are hereby incorporated herein by reference for all purposes as if fully set forth herein.

### TECHNICAL FIELD OF THE INVENTION

The present invention is directed to methods for searching for television programs, and, more particularly, to an improved method for identifying key objects (e.g., keywords) within Internet documents during an Internet session and using the key objects to search for and locate television programs.

### BACKGROUND OF THE INVENTION

Prior art systems and methods exist that are capable of obtaining information from Internet sites and incorporating the information within a video program. For example, U.S. Pat. No. 6,018,768 issued on Jan. 25, 2000 to Ullman et al. discloses a system that obtains information segments from the Internet and incorporates and displays the Internet information segments within a video program. The Internet information segments may comprise images of Web pages or the addresses of Web pages. The addresses of Web pages are referred to as “uniform resource locators” or “URLs.”

Other prior art systems are capable of using search engines available on the Internet to search through computerized television program guides to find television programs of interest a viewer. In these types of systems, a viewer uses a personal computer to send one or more keywords to an Internet search engine. The Internet search engine uses the keywords to search through one or more computerized television program guides to locate television programs that contain the keywords. The Internet search engine then compiles a list of search results that identifies the television programs that contain the keywords. The Internet search engine then sends the search results to the viewer's personal computer. The viewer then selects one or more television programs from the search results and sends instructions to a video recorder to record the television programs when the television programs are broadcast. In this type of system, the viewer submits the desired keywords to the Internet search engine to start the search process.

However, in many instances when a viewer is accessing Internet documents, the viewer will not know in advance what keywords will be of interest to the viewer. That is, when the viewer is sequentially moving from one Internet document to another (i.e., “surfing” the Internet) the viewer will often find new topics of interest that were previously unknown to the viewer. The identification of new keywords of interest will occur throughout the viewer's Internet session. The viewer will naturally be interested to know what, if any, television programs exist that are related to the new keywords of interest and when the television programs will be broadcast.

For example, assume a student is studying a topic in astronomy for a school project. As the student is surfing the Internet to find information on the topic, the student may find new keywords of interest that relate to the topic. The student will be interested to know if any television programs exist that relate to the topic in astronomy that he or she is researching. The student will also want to know the time and channel on which the television programs will be shown. The student may also want to have his or her video recorder programmed to automatically record the television programs.

There is therefore a need in the art for a method for searching for television programs that will permit a viewer to select new keywords within Internet documents when the viewer identifies the keywords during an Internet session. There is also a need in the art for a method for searching for television programs that will permit a viewer to automatically compile a list of newly identified keywords during an Internet session. There is also a need in the art for a method for searching for television programs that will permit a viewer to use a list of newly identified keywords to search for television programs that contain the keywords.

### SUMMARY OF THE INVENTION

The present invention generally comprises an improved method for identifying keywords within Internet documents during an Internet session and using the keywords to search for and locate television programs.

In an advantageous embodiment of the present invention, the improved method of the invention comprises the steps of: 1) identifying keywords in Internet documents, 2) sending the keywords to a search capable video recorder, 3) conducting a keyword search with the search capable video recorder to locate television programs that contain the keywords, 4) providing to a viewer the search results of the keyword search that identify television programs that contain the keywords, 5) selecting television programs that contain the keywords in response to a viewer instruction, and 6) recording the television programs that are selected by the viewer from the search results.

It is a primary object of the present invention to provide an improved method for searching for and locating television programs.

It is another object of the present invention to provide an improved method for searching for and locating television programs with new keywords that a viewer identifies and selects from Internet documents.

It is an additional object of the present invention to provide an improved method for searching for and locating television programs using a keyword search conducted by a search capable video recorder.

It is also another object of the present invention to provide an improved method for searching for and locating television programs using a keyword search that automatically selects keywords based on a previously recorded personal profile of keywords.

It is also an additional object of the present invention to provide an improved method for searching for and locating television programs using a keyword search that automatically expands a list keywords by obtaining synonyms of previous keywords.

It is another object of the present invention to provide an improved method for searching for and locating television programs using a keyword search that automatically analyzes the text of Internet documents to identify main topics and important keywords.

It is another object of the present invention to provide an improved method for searching for and locating television programs that permits a viewer to select for recording one or more television programs that have been located by a keyword search of one or more electronic databases.

It is another object of the present invention to provide an improved method for searching for and locating television programs that permits a viewer to select for recording one or more television programs that have been located by a keyword search that analyzes television program video streams.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a block diagram that illustrates an advantageous embodiment of a system in which the improved method of the present invention may be used; and

FIG. 2 is a flow chart diagram illustrating an advantageous method of operation of the improved system of the present invention.

### DETAILED DESCRIPTION OF THE INVENTION

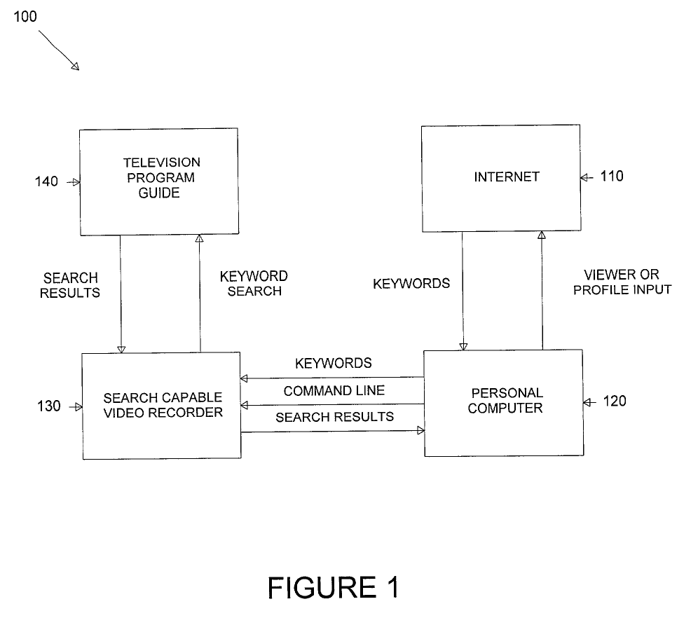

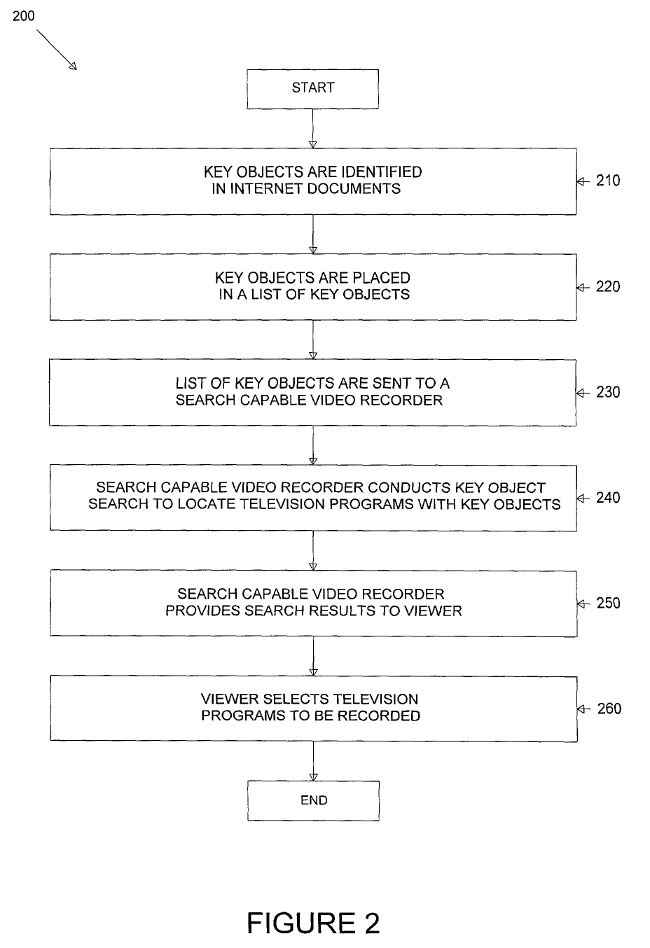

FIGS. 1 and 2, discussed below, and the various embodiments set forth in this patent document to describe the principles of the improved method of the present invention are by way of illustration only and should not be construed in any way to limit the scope of the invention. The improved method of the present invention will be described for use in connection with a search capable video recorder. Those skilled in the art will readily understand that the principles of the present invention may also be successfully applied in other similar types of recording devices.

FIG. 1 is a block diagram of system 100 in which the improved method of the present invention may be used. In system 100 a viewer accesses Internet 110 from personal computer 120. Although this advantageous embodiment of the present invention employs a personal computer, it is clear that the invention is not limited to use with a personal computer. That is, it is clear that other types of equipment may also be employed. For example, personal computer 120 may comprise a Web enabled set top box, a personal digital recorder, a personal video recorder, or other similar types of electronic equipment. The term “personal computer 120” shall refer to a personal computer and to other types of similar equipment.

As the viewer sequentially moves from one Internet document to another, the viewer finds topics of interest. The viewer identifies words in each Internet document that the viewer wants to serve as keywords for a search. The keywords that are selected by the viewer are automatically sent to personal computer 120. There they are placed in a list of search keywords as the viewer continues the Internet session.

The keywords identified by the viewer may serve as a basis for an expanded set of keywords. For example, each keyword may be sent to a database (e.g., WordNet) that is capable of providing a list of synonyms for keywords. For example, if the keyword is “car,” then the expanded set of keywords would add synonyms such as “automobile” and “vehicle.” Even slang words such as “hot-rod” or “jalopy” could be added.

The keywords identified by the viewer may also be added to a personal profile of keywords that reflect the viewer's interests. More than one personal profile of keywords may exist with each personal profile of keywords containing a list of keywords relating to a particular topic.

In an alternative embodiment, the text of the Internet documents that are accessed by the viewer are automatically compared with a previously created list of keywords in personal computer 120. In this manner, search keywords are automatically extracted from the Internet document if they match a previously created “personal profile” list of keywords of the viewer.

In an alternative embodiment, the text of an Internet document is automatically analyzed using well known natural language processing techniques in order to extract the main topic of the Internet document and important keywords in the document. One such method is described by Chin-Yew Lin in an article entitled “Assembly of Topic Extraction Modules in Summarist,” American Association of Artificial Intelligence, Spring 1998 Symposium on Intelligent Text Summarization, pp. 53-59 (1998). The topic and the keywords are added to the viewer's personal profile and are used to search for relevant television programs.

The documents analyzed for keyword extraction are not only the current document, but also the trail of documents that were opened and reviewed before the final document was reached. The method of the present invention can identify the topics (i.e., titles) of all the documents and the different “clicks” (i.e., the sequence of URLs) that were taken along the path. For example, the viewer could start at the CNN Web page, then work through the headline news page, and then go to the George W. Bush page. Each document along the way can be analyzed with a keyword extraction technique.

The list of search keywords may be used to search for television programs that contain the search keywords. In response to a viewer instruction, the list of the search keywords are sent to search capable video recorder 130. Search capable video recorder 130 comprises an apparatus that is capable of conducting a keyword search. Search capable video recorder 130 may comprise an apparatus such as that described in U.S. patent application Ser. No. 09/442,960 filed Nov. 18, 1999 by Dimitrova et al. entitled “Method and Apparatus for Audio/Data/Visual Information Selection.”

Search capable video recorder 130 may be a video recorder with a hard disk drive memory, a television set with a video recorder with a hard disk drive memory, a set top box with a video recorder having a hard disk drive memory, a video cassette recorder with a hard disk drive memory, or a personal computer with a video card. Search capable video recorder 130 is capable of receiving the list of search keywords from personal computer 120 and conducting a search of computerized databases.

For example, FIG. 1 shows search capable video recorder 130 coupled to television program guide 140. Search capable video recorder 130 uses the list of search keywords to conduct a search for matching words within the television programs listed in television program guide 140. The keyword search is conducted for a predetermined length of time referred to as the “time allotted for conducting the search.” As television programs are located that contain a matching keyword in the television program guide 140, search capable video recorder 130 sends the search results to personal computer 120. Alternatively, after the search has been completed (or after the time allotted for conducting the search has expired), search capable video recorder 130 sends the search results to personal computer 120.

Search capable video recorder 130 uses information from the search results to record the selected television programs at the times that they are broadcast. In one embodiment of the method of the present invention, search capable video recorder 130 sends the search results to personal computer 120 so that the viewer can review the search results and give instructions concerning which of the television programs to record.

In another embodiment of the method of the present invention, search capable video recorder 130 automatically records the television programs and sends notification to the viewer (at personal computer 120) that the television programs have been recorded. If the viewer desires to delete the recorded television programs, the viewer can then send an instruction to delete the television programs that were automatically recorded.

In another embodiment of the method of the present invention, search capable video recorder 130 is capable of selecting television programs from the search results with a selection criterion. For example, the selection criterion may be to select only those television programs that will be shown in a particular time period (e.g., within the next two days). The selection criterion may be to select only those television programs that are deemed to be the most relevant to a particular topic. The selection criterion may be to select and record all television programs that appear in the search results until the disk space limit of search capable video recorder 130 has been reached. The selection criterion may be to overwrite (or not overwrite) recorded programs.

In another embodiment of the method of the present invention, search capable video recorder 130 is instructed to record all of the television programs that appear in the search results.

In addition to searching computerized databases like television program guide 140, search capable video recorder 130 is capable of conducting other types of searches. Search capable video recorder 130 can identify television programs using program identification (ID) information, when such information is available. Search capable video recorder 130 can also identify television programs by analyzing video streams of the television programs to find words that match the search keywords. Search capable video recorder 130 can also identify television programs by analyzing metadata and abstracts of the television programs to find words in the television programs that match the search keywords. Search capable video recorder 130 can also search the content of television programs that have previously been recorded to identify television programs that contain words that match the search keywords.

The method of the present invention has been described with reference to locating keywords in textual material. There are some Web pages, for example, that contain video material and no text. The method of the present invention, however, is also capable of locating images, video segments, and audio segments. For example, a video image (i.e., a “still” image) can serve as a “key image” in a manner analogous to a keyword to find matching video images. A video segment (i.e., a video “clip”) can serve as a “key video segment” in a manner analogous to a keyword to find matching video segments. An audio segment can serve as a “key audio segment” in a manner analogous to a keyword to find matching audio segments. Images, video segments, and audio segments can be located using an apparatus such as that described in U.S. patent application Ser. No. 09/442,960 filed Nov. 18, 1999 by Dimitrova et al. entitled “Method and Apparatus for Audio/Data/Visual Information Selection.”

Image matching techniques, video matching techniques, and audio matching techniques are well known in the art. For a description of such techniques, refer to an article by M. S. Abdel-Mottaleb et al. entitled “MPEG-7 Applications and Supporting Technologies,” International Workshop on Very Low Bitrate Video Coding (VLBV), Urbana, Ill. (October 1998). Software companies such as Virage, ISLIP, Magnifi, among others, create software for image matching, video matching, and audio matching.

The term “key object” will be used to generally designate the terms “keyword”, “key image”, “key video segment”, and “key audio segment.” The term “object” will be used to generally designate the terms “word”, “image”, “video segment”, and “audio segment.”

FIG. 2 is a flow chart diagram illustrating one advantageous method of operation of the present invention. The steps in the method of operation shown in FIG. 2 are collectively identified with reference numeral 200. The viewer accesses the Internet and views Internet documents. Key objects are identified in the Internet documents (step 210). The viewer may identify key objects in the Internet documents or the key objects may be identified from a viewer profile. As the key objects are identified, the key objects are placed in a list of key objects (step 220).

The list of key objects is then sent to search capable video recorder 130 (step 230). Search capable video recorder 130 then conducts a key object search to locate television programs that contain at least one key object (step 240). After the search has been completed, search capable video recorder 130 provides the results of the search to the viewer (step 250). The viewer then selects the television programs to be recorded by search capable video recorder 130 (step 260).

Although the present invention has been described in detail, those skilled in the art should understand that they can make various changes, substitutions and alterations herein without departing from the spirit and scope of the invention in its broadest form.

What is claimed is:

1. A method for searching for television programs comprising the steps of:
identifying at least one key object in at least one Internet document;
sending said at least one key object to a search capable video recorder; and
conducting a key object search with said search capable video recorder to locate at least one television program that contains said at least one key object.

2. The method as claimed in claim 1 further comprising the steps of:
identifying a plurality of key objects in at least one Internet document;
placing said plurality of key objects in a list of key objects;
sending said list of key objects to said search capable video recorder; and
conducting a key object search with said search capable video recorder to locate at least one television program that contains at least one key object in said list of key objects.

3. The method as claimed in claim 2 further comprising the step of:
increasing the number of said plurality of key objects in said list of key objects by adding key objects to said list that are similar to said plurality of key objects in said list of key objects.

4. The method as claimed in claim 1 further comprising the steps of:
providing search results of said key object search to a viewer, said search results identifying at least one television program that contains at least one key object;
selecting at least one television program that contains at least one key object in response to a viewer instruction; and
recording in said search capable video recorder said at least one television program selected by said viewer.

5. The method as claimed in claim 1 further comprising the steps of:
receiving in said search capable video recorder search results of said key object search, said search results containing at least one television program that contains at least one key object; and
recording in said search capable video recorder at least one of the television programs identified in said search results.

6. The method as claimed in claim 5 further comprising the steps of:
using a selection criterion to select a t least one television program from said search results to be recorded.

7. The method as claimed in claim 6 wherein said selection criterion comprises one of: selecting only those television programs that will be shown in a particular time period, selecting only those television programs that are deemed to be the most relevant to a particular topic, selecting all television programs that appear within a search result until the disk space limit of a search capable video recorder has been reached, selecting television programs that may be overwritten by said search capable video recorder, and selecting television programs that may not be overwritten by said search capable video recorder.

8. The method as claimed in claim 5 further comprising the step of:
recording in said search capable video recorder all of the television programs identified in said search results.

9. The method claimed in claim 1 wherein said key object search is conducted for a predetermined period of time.

10. The method as claimed in claim 1 wherein said key object search identifies at least one television program using program identification information.

11. The method as claimed in claim 1 wherein said key object search identifies at least one television program by analyzing at least one video stream of at least one television program to find objects that match the key objects used in said key object search.

12. The method as claimed in claim 1 wherein said search capable video recorder comprises one of: a video recorder with a hard disk memory, a television set with a video recorder with a hard disk memory, a set top box with a video recorder with a hard disk memory, a video cassette recorder with a hard disk memory, and a personal computer with a video card.

13. A method for searching for television programs comprising the steps of:
identifying at least one key object in at least one Internet document;
sending said at least one key object to a search capable video recorder;
conducting a key object search with said search capable video recorder to locate at least one television program that contains said at least one key object;
providing search results of said key object search to a viewer, said search results identifying at least one television program that contains at least one key object;
selecting at least one television program that contains at least one key object in response to a viewer instruction; and
recording in said search capable video recorder said at least one television program selected by said viewer.

14. The method as claimed in claim 13 further comprising the step of:
conducting said key object search in said search capable video recorder in television programs that have previously been recorded in said search capable video recorder.

15. The method as claimed in claim 13 wherein said key object search is conducted for a predetermined period of time.

16. The method as claimed in claim 13 wherein said key object search identifies at least one television program using program identification information.

17. The method as claimed in claim 13 wherein said key object search identifies at least one television program by analyzing at least one video stream of at least one television program to find objects that match the key objects used in said key object search.

18. The method as claimed in claim 13 wherein said search capable video recorder comprises one of: a video recorder with a hard disk memory, a television set with a video recorder with a hard disk memory, a set top box with a video recorder with a hard disk memory, a video cassette recorder with a hard disk memory, and a personal computer with a video card.

19. A method for searching for television programs comprising the steps of:
identifying a plurality of key objects in at least one Internet document;
placing said plurality of key objects in a list of key objects;
sending said list of key objects to said search capable video recorder;
conducting a key object search with said search capable video recorder to locate at least one television program that contains at least one key object in said list of key objects;
providing search results of said key object search to a viewer, said search results identifying at least one television program that contains at least one key object;
selecting at least one television program that contains at least one key object in response to a viewer instruction; and
recording in said search capable video recorder said at least one television program selected by said viewer.

20. The method as claimed in claim 19 wherein said key object search is conducted for a predetermined period of time.

21. The method as claimed in claim 19 wherein said key object search identifies at least one television program using program identification information.

22. The method as claimed in claim 19 wherein said key object search identifies at least one television program by analyzing at least one video stream of at least one television program to find objects that match the key objects used in said key object search.

23. The method as claimed in claim 19 wherein said search capable video recorder comprises one of: a video recorder with a hard disk memory, a television set with a video recorder with a hard disk memory, a set top box with a video recorder with a hard disk memory, a video cassette recorder with a hard disk memory, and a personal computer with a video card.

24. The method as claimed in claim 19 further comprising the step of:
notifying said viewer when said search capable video recorder has recorded said at least one television program selected by said viewer.
